(19) United States
(12) Patent Application Publication
(10) Pub. No.: US 2011/0139049 A1
(43) Pub. Date: Jun. 16, 2011

(54) REFRACTORY WALL FOR A COMBUSTION FURNACE

(75) Inventors: Andreas KERN, Basel (CH); Hans Petschauer, Grossalmerode (DE)

(73) Assignee: Mokesys AG, Birsfelden (CH)

(21) Appl. No.: 13/035,722

(22) Filed: Feb. 25, 2011

Related U.S. Application Data
(63) Continuation of application No. PCT/CH2009/000276, filed on Aug. 21, 2009.

(30) Foreign Application Priority Data
Aug. 26, 2008 (CH) 1361/08

(51) Int. Cl. F23M 5/00; F27D 1/00

(52) U.S. Cl. 110/336; 432/252

(57) ABSTRACT

A fireproof wall intended, in particular, for use in a combustion furnace has a tube wall of tubes connected by webs and a fireproof and fire-tight protective lining which is arranged upstream of the tube wall at a distance therefrom and has a plurality of fireproof plates (tiles) which are arranged alongside and above each other and are fastened to the webs of the tube wall via in each case at least one plate mounting. An intermediate space is present between the tube wall and the protective lining and, at least in certain zones, contains a particulate filler material which increases the transfer of heat between the protective lining and the tube wall. Material selection and the zonal local distribution of the particulate filler material make it possible to deliberately influence the transfer of heat both quantitatively and locally and therefore to optimally adapt it to the respective operating requirements of the combustion furnace.

### CROSS-REFERENCE TO RELATED APPLICATION

This application is a continuation of International Patent Application No. PCT/CH2009/000276 filed on Aug. 21, 2009 the contents of which are hereby incorporated by reference in their entirety.

### FIELD OF THE INVENTION

The invention relates to a refractory wall for a combustion furnace.

### BACKGROUND

Refractory walls are used, e.g., in fire chambers of incinerating plants. The boiler wall is often designed as metal tube wall, typically consisting of tubes connected by webs. The refractory and fire-tight protective lining suspended in front of and spaced from the tube wall is designed to protect the tube wall from corrosion by smoke gas. Refractory walls are e.g. also used in fluidized-bed furnaces, in which the boiler wall consists of a single more or less thick metal wall. Here, too, the boiler wall or metal wall is to be protected from corrosion.

The boiler walls and protective linings often experience temperatures exceeding 1000° C. in today's combustion furnaces, and even with adequate materials they undergo expansions and contractions due to the considerable differences in temperature of various operating conditions. These differences in temperature are generally much greater for the protective linings than the boiler walls themselves, which must be taken into consideration when choosing materials and/or designing the protective linings, so that the protective linings are not destroyed by expansions and contractions greater than those found in the boiler walls. The protective linings or the plates of these are therefore typically not rigidly fixed to the boiler walls, but are rather given play to allow compensatory movement to a certain degree parallel to the boiler walls.

The selection of a suitable material for the protective lining makes possible that the protective lining is matched to the boiler wall for any operating state. For boiler walls of steel, protective linings of ceramic materials, in particular SiC, have proved suitable, while the SiC content can vary greatly. In practice, SiC compounds or SiC tiles with SiC content of 30%-90% are employed.

The plates of the protective lining are generally sealed against one another to a certain degree through various measures in order to prevent the passage of smoke gasses. In practice, however, this cannot entirely prevent that corrosive smoke gasses can traverse the protective lining and attack the boiler wall.

European Patent document EP 1 032 790 B1 sets forth a generic refractory wall where the plates (tiles) of the protective lining have a tongue-and-groove structure or complimentarily staggered edges such that a certain level of tightness is retained even when thermal conditions cause the plates to move against one another and at least a direct flow-through of smoke gas is prevented. Plate inter-sealing is further reinforced with ceramic fiber strips which are arranged between the plates in the region of the tongue-and-groove structures or the complimentarily staggered edges. The space between the tube wall and the protective lining is also filled with fluid SiC concrete, creating an additional sealing effect between the plates and the tube wall. On the other hand, filling this space with fluid concrete directly connects the protective lining plates with the tube wall, reducing the flexibility of the wall system with regard to heat transfer requirements. In addition, there is the risk that faulty use of the combustion furnace, such as starting or stopping too quickly, will cause the protective lining to release from the tube wall or in general the boiler wall.

From German Patent document DE 198 16 059 C2 a refractory wall with a tube wall and a spaced protective lining consisting of a plurality of fire-tight plates located in front is known, wherein the (unfilled) intermediate space between tube wall and the protective lining is designed as at least one closed pressure chamber, wherein each pressure chamber is charged with pressurized protective gas. The overpressure of the protective gas is so great that no smoke gas from the combustion furnace can enter through the protective lining. This achieves relatively effective corrosion protection; however, the isolation effect of the protective gas hinders the heat transfer between protective lining and the tube wall, so that depending on the use not sufficient heat can be removed.

Given the disadvantages of these known refractory wall systems, a goal of the invention is to improve a refractory wall in such a way as to ensure sufficient heat transfer between the protective lining and the boiler wall while also allowing the heat transfer to be quantitatively and locally controlled in a targeted manner.

### SUMMARY

In accordance with the invention, a refractory wall, particularly for a combustion furnace, has a boiler wall (not limited to use in a boiler) and a refractory and fire-tight protective lining placed in front of and spaced from the boiler wall and has a multiplicity of refractory plates (tiles) arranged alongside and above one another, each fastened to the boiler wall with at least one plate mounting. An intermediate space is provided between the boiler wall and the protective lining. A particulate filling is arranged in at least one portion of the intermediate space.

The particulate filling between boiler wall and protective lining greatly improves heat transfer from the protective lining to the boiler wall.

According to one embodiment, the particulate filling is arranged in zones of the wall or its intermediate space, respectively. Here individual zones may have a differing particulate filling, or not be filled at all. This zonal distribution and arrangement of the particulate filling, as well as the appropriate choice of material, allows the heat transfer within the wall to be controlled in a targeted manner, so operational requirements can be optimally met.

In one embodiment, particulate filling with a porosity of 15 to 70% is used. In this way, the refractory wall according to the invention can additionally be designed as a back-ventilated system.

In the following, the refractory wall according to the invention is described in more detail by means of two exemplary embodiments making reference to the drawings.

### BRIEF DESCRIPTION OF THE FIGURES

FIG. 1 is a first exemplary embodiment of the wall according to the invention in a view onto the protective lining;

FIG. 2 shows a cross-section along line II-II in FIG. 1;

FIGS. 3-4 show sections from FIG. 2 in an enlarged representation;

FIG. 5 is a detail drawing similar to FIG. 4 explaining the air supply to the wall;

FIG. 6 is a schematic drawing explaining the air discharge from the wall;

FIG. 7 is a schematic drawing of the layout of the air supply nozzles;

FIG. 8 is a sectional representation similar to FIG. 2 of a second exemplary embodiment of the wall according to the invention; and

FIG. 9 is a cross-section of a grain of a particulate filling.

### DETAILED DESCRIPTION

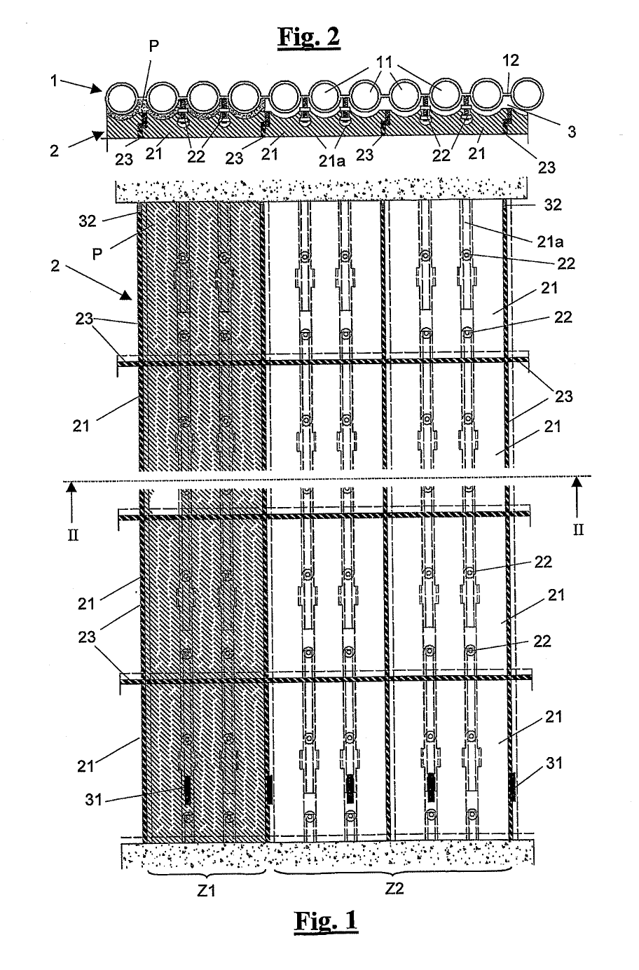

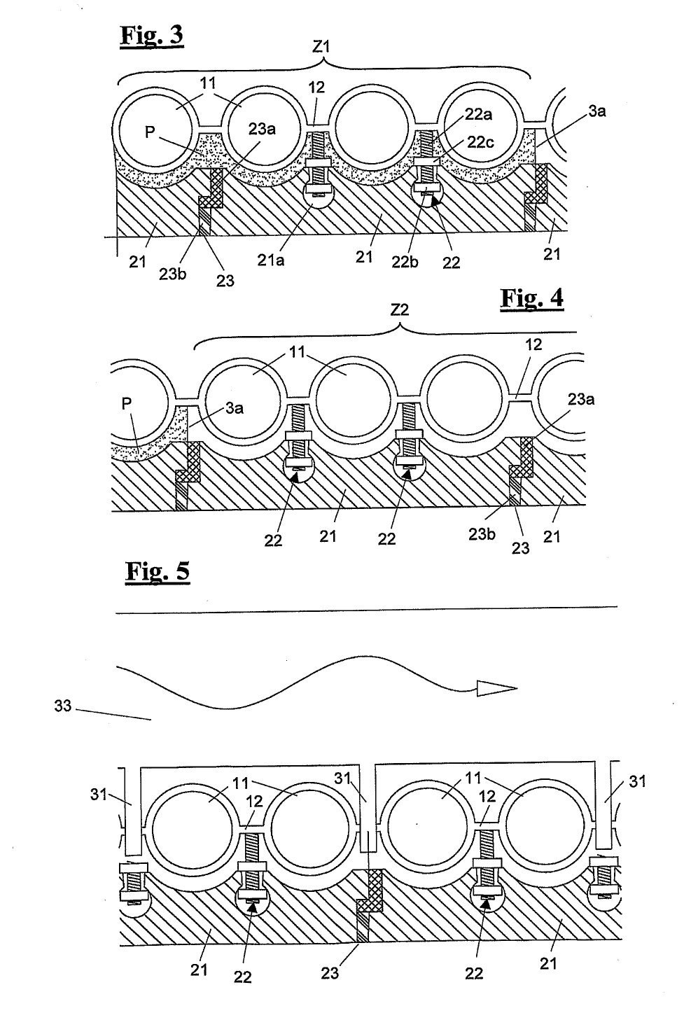

The first exemplary embodiment of the refractory wall according to the invention shown in FIGS. 1-7 includes a tube wall 1 serving a boiler wall (see FIGS. 2-5) and a protective lining 2 placed in front of and spaced from the tube wall, an intermediate space 3 being provided between the tube wall 1 and the protective lining 2. The tube wall 1 consists of a multiplicity, in practical use, of vertical tubes 11, which are held together by mutually spaced by webs 12. The tubes 11 and the webs 12 are usually made of steel. The protective lining 2 consists of a multiplicity of refractory plates 21 arranged alongside and on one another, which engage in one another through, e.g., complementary shaping of their edges and in this manner are mutually sealed to a certain degree. The separating joints between the plates 21 are designated 23. The plates for example are ceramic SiC plates, preferably SiC 90 plates with a SiC content of approximately 90% in production, which are fire-resistant to above 1000° C. Each plate 21 is fastened to the tube wall 1 by means of, e.g., four plate mountings 22. The plate mountings consist of heat-resistant steel, e.g., steel number 310 according to the AISI standard or material number 1.4845 according to DIN 17440. The plate mountings 22 each include a stud bolt 22a welded to a web 12 and two nuts 22b and 22c screwed on the stud bolt (see FIGS. 3-5). The plate mountings 22 engage in vertical, inwardly extending slots 21a in the plates 21 and determine the spacing of the plates 21 from the tube wall. In the vertical direction of the protective lining 2, the plates 21 are movable to a certain degree so as to allow thermally-related expansion or contraction movements. The side of plates 21 facing the tube wall define cylindrical grooves to conform to the tubes 11, so that the clearance (gap width) of the intermediate space 3 between the tube wall 1 and the protective lining 2 is substantially roughly constant over the entire wall. Typical gap widths are 5 to 20 mm, preferably 5 to 10 mm. To this extent, the refractory wall essentially corresponds to that, e.g., in Patent document EP 1 032 790 B1 incorporated hereby by reference in its entirety, and thus requires no further elaboration.

One difference from the state of the art lies in the fact that the intermediate space 3 between the boiler wall, here the tube wall 1, and the protective lining 2 is partially or completely filled with a particulate filling (granulate) P. The particulate filling P consists of ceramic or metallic materials such as SiC, has a grain size of approximately 1 to 10 mm, preferably 3 to 7 mm, and a porosity of approximately 15 to 70%. Filling the intermediate space 3 with the particulate filling P increases the heat transfer from the protective lining 2 to the boiler wall—here tube wall 1—via thermal conduction. This increase is dependent upon the selected material and the thermal conduction characteristics of the selected material and can be regulated to a broad extent. The open porosity of the particulate filling P also allows for implementing a back-ventilated wall system, described in further detail below.

In the operation of a combustion furnace, thermal conduction requirements can vary locally due to factors such as the temperature profile in the combustion chamber and the process engineering involved. In accordance with a further aspect of the invention, these can be accommodated due to the fact that the refractory wall and the intermediate space 3 between the protective lining 2 and the boiler wall, here the tube wall 1, is partitioned or subdivided into different zones and the individual zones are filled in different manners or with different particulate fillings P or not filled at all. In this way, the heat transfer from the protective lining to the tube wall can be optimally adapted to the operational requirements of the combustion furnace, both quantitatively as well as locally through various zones. In FIGS. 1 to 4, two such zones Z1 and Z2 are shown as examples. The subdivision into zones is done according to operational requirements and can of course also be done so vertically. The intermediate space 3 can be spatially partitioned into individual zones with e.g. partition plates 3a as schematically indicated in FIGS. 3 and 4.

In accordance with an advantageous aspect of the invention, the particulate filling P can be enclosed in a thin layer of a mineral or ceramic binding agent as shown in detail in FIG. 9. The actual filling forms the core Pk, and the, e.g., approximately 100μ thick binding agent coating or layer is designated Pb. The binding agent is preferably a material that first activates, i.e. starts binding at high temperatures, e.g. over 100° C. As long as the particulate filling P is only exposed to lower temperatures, the binding agent is inactive and the particulate filling remains fluid. However, should the activation temperature be locally exceeded, for example by a break in one of the plates 21, the binding agent starts bonding and binding and locally agglomerates the particulate filling, thus preventing leaks from the break in the protective lining.

In accordance with an additional advantageous aspect of the invention, the refractory wall additionally is a back-ventilated wall system. This means that a gas—usually air—flows through the intermediate space 3 between the protective lining 2 and the boiler wall, here the tube wall 1, during operation. The gas can also pass through the particulate filling P due to its open porosity. The gas or air in the intermediate space is pressurized to approximately 2 to 50 mbar during operation, and exceeds the pressure of the furnace combustion chamber by approximately 2 to 10 mbar. This prevents corrosive smoke gasses from escaping the combustion chamber through unsealed areas in the protective lining into the intermediate space 3 and attacking the tube wall 1.

For the gas supply into and gas discharge out of the intermediate space 3 of the wall, inlet nozzles 31 and vent openings 32 are provided in the wall. The inlet nozzles 31 are connected to one or more air supply channels 33 and fed by these (see FIG. 5). The gas or air is supplied from the boiler wall side, where the inlet nozzles 31 penetrate the boiler wall, here the tube wall 1, in the area of its webs 12 (see FIG. 5). The vent openings 32 penetrate the protective lining 2, discharging the gas flowing through the intermediate space 3 into the furnace chamber.

The inlet nozzles 31 are provided with protection. This means that the particulate filling P cannot flow into the inlet nozzles and form a blockage. This can be achieved by, e.g., tilting the inlet nozzles downward. The vent openings 32 may likewise have protection, so that the particulate filling P cannot be blown out through them.

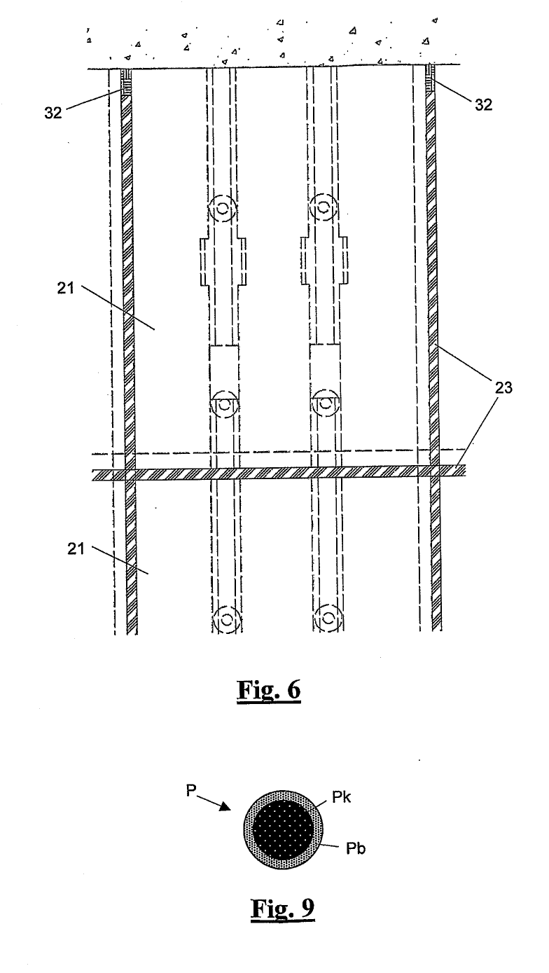

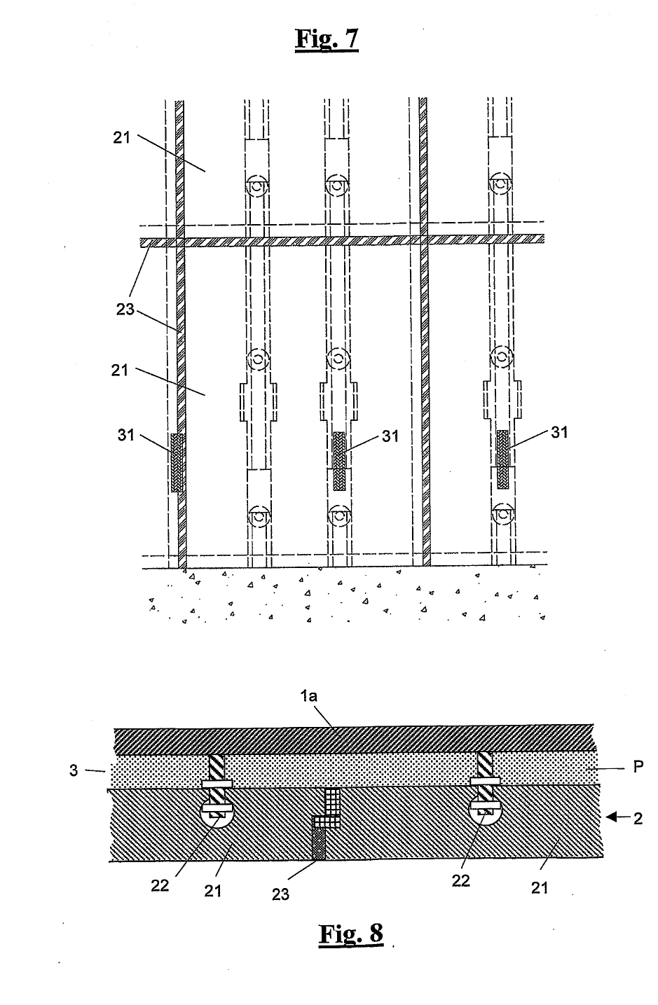

The vent openings 32 are preferably arranged near the upper edge of the refractory wall, as indicated schematically in FIGS. 1 and 6. The inlet nozzles 31 can be arranged at the foot of the wall, i.e. near the lower edge, as indicated in FIGS. 1 and 7. However, the inlet nozzles 31 are preferably distributed along the entire surface of the wall or along individual areas of the same.

In accordance with an additional advantageous aspect of the invention, the plates 21 of the protective lining 2 are doubly inter-sealed. As particularly evident from FIGS. 3 and 4, the Z shaped plate joints 23 of the protective lining 2 are sealed by inlaid refractory ceramic sealing strips 23a and an additional luting compound 23b. The felt strips 23a provide a certain amount of flexibility; however, they do not provide an absolute seal. This seal is achieved by the additional luting sealant 23b.

As mentioned above, the boiler wall of the refractory wall according to the invention need not be a tube wall; it can also be a conventional metal wall. FIG. 8 schematically shows a second exemplary embodiment in which the boiler wall is such a flat metal wall 1a. If need be, this exemplary embodiment can also be filled in zones with the particulate material P to effect the mentioned advantages.

1. A refractory wall having a boiler wall and a refractory lining spaced from the boiler wall and comprising:
a plurality of refractory plates arranged alongside and above one another, each fastened to the boiler wall by at least one mounting wherein the refractory lining is fire-tight,
an intermediate space defined between the boiler wall and the refractory lining, and
a particulate filling in at least one portion of the intermediate space.

2. A wall according to claim 1, wherein the intermediate space is partitioned into zones, and the particulate filling is arranged in at least one zone.

3. A wall according to claim 2, wherein at least two of the zones have differing particulate fillings.

4. A wall according to claim 1, wherein the particulate filling has a grain size of 1 to 10 mM.

5. A wall according to claim 1, wherein the particulate filling has a porosity of 15 to 70%.

6. A wall according to claim 1, wherein the particulate filling includes ceramic or metallic materials.

7. A wall according to claim 1, wherein the particulate filling is coated with a ceramic or mineral binding agent that activates at high temperatures.

8. A wall according to claim 1, wherein a width of the intermediate space is 5 to 20 mM.

9. A wall according to claim 1, further comprising plate joints located between the refractory plates and that are sealed by ceramic sealing strips and a luting compound.

10. A wall according to claim 1, further comprising:
a port for supplying gas to the intermediate space, and
a port for discharging gas from the intermediate space.

11. A wall according to claim 10, wherein the supplying port comprises protected inlet nozzles that penetrate the boiler wall and are such as to inhibit clogging by the particulate filling.

12. A wall according to claim 11, wherein the inlet nozzles are arranged in a lower region of the refractory wall or distributed over the refractory wall surface.

13. A wall according to claims 10, wherein the discharging port comprises vent openings that penetrate the refractory lining and are arranged in a upper region of the refractory wall.

14. A wall according to claim 1, wherein the boiler wall comprises tubes connected by webs.
